(19) United States
(12) Patent Application Publication
(10) Pub. No.: US 2022/0343379 A1
(43) Pub. Date: Oct. 27, 2022

(54) BILLING MANAGEMENT FOR SOLUTION INSTALLED IN IMAGE FORMING APPARATUS

(71) Applicant: HEWLETT-PACKARD DEVELOPMENT COMPANY, L.P., Spring, TX (US)

(72) Inventors: JungHun KIM, Seongnam-si, Gyeonggi-do (KR); Minyoung SON, Seongnam-si, Gyeonggi-do (KR); JinKyu KOOK, Seongnam-si, Gyeonggi-do (KR); ByeongJu HWANG, Seongnam-si, Gyeonggi-do (KR); Junhyung YOO, Seongnam-si, Gyeonggi-do (KR)

(21) Appl. No.: 17/760,832

(22) PCT Filed: Sep. 2, 2020
(86) PCT No.: PCT/US2020/049017

§ 371 Date: Mar. 16, 2022

(30) Foreign Application Priority Data
Mar. 27, 2020 (KR) 10-2020-0037402

(51) Int. Cl. G06Q 30/04; H04N 1/00; H04N 1/34

(52) U.S. Cl. CPC G06Q 30/04; H04N 1/00938; H04N 1/00244; H04N 1/344; H04N 2201/0094

(57) ABSTRACT

An example billing management method with respect to a solution installed in an image forming apparatus includes detecting a solution newly installed in or removed from the image forming apparatus, based on a solution list indicating solutions installed in the image forming apparatus, verifying whether the detected solution is included in a solution subscription list corresponding to an account in which the image forming apparatus is registered, and processing billing with respect to the detected solution according to a verification result.

### BACKGROUND

An image forming apparatus such as a multifunctional printer may support basic functions such as print, scan, copy, and fax functions, and a user may use a corresponding function by executing a system-provided application corresponding to each basic function in the image forming apparatus.

In order to expand the types of functions supported by an image forming apparatus or address errors that may occur in the image forming apparatus, a cloud platform has been used to provide a solution in the form of an application or firmware developed by a third party or a vendor of the image forming apparatus to the image forming apparatus. In that case, a billing server may be used to charge for the use of the solution in an account in which the image forming apparatus provided with the solution is registered.

### BRIEF DESCRIPTION OF THE DRAWINGS

FIG. 1 is a diagram illustrating a service environment in which an image forming apparatus is provided with a solution according to an example.

FIG. 2 is a diagram illustrating an image forming apparatus according to an example.

FIG. 3 is a diagram illustrating a cloud server according to an example.

FIG. 4 is a diagram illustrating a portal server according to an example.

FIG. 5 is a diagram illustrating a billing server according to an example.

FIG. 6 is a diagram illustrating a billing process in which a cloud server periodically detects a solution newly installed in or removed from an image forming apparatus, and a portal server confirms a solution subscription list stored in the portal server to request billing according to an example.

FIG. 7 is a diagram illustrating a billing process in which a cloud server periodically detects a solution newly installed in or removed from an image forming apparatus, and a billing server confirms a solution subscription list received from a portal server to process billing according to an example.

FIG. 8 is a diagram illustrating a billing process in which a cloud server newly installs or removes a solution in or from an image forming apparatus, and a billing server confirms a solution subscription list received from a portal server to process billing according to an example.

FIG. 9 is a diagram illustrating a billing process in which a portal server manages a solution in which a cloud server newly installs in or removes from an image forming apparatus in a database and confirms a solution subscription list stored in the portal server to request billing according to an example.

FIG. 10 is a diagram illustrating a database managed by a portal server according to an example.

FIG. 11 is a diagram illustrating a billing process in which a cloud server periodically detects a solution newly installed in or removed from an image forming apparatus, and a portal server manages the detected solution in a database and confirms a solution subscription list stored in the portal server to request billing according to an example.

FIG. 12 is a diagram illustrating a billing process in which a cloud server periodically detects a solution newly installed in or removed from an image forming apparatus, and a portal server manages the detected solution in a database and confirms a solution subscription list stored in the portal server to periodically request billing according to an example.

FIG. 13 is a flowchart illustrating a billing management method with respect to a solution installed in an image forming apparatus according to an example.

### DETAILED DESCRIPTION OF EXAMPLES

In the present disclosure, the term “solution” may refer to software that processes errors associated with a software package, an application program, or an application installed in an image forming apparatus. A solution may be provided to the image forming apparatus from a cloud server by upgrading an existing installed application or firmware or providing a new application or firmware. In the present disclosure, the term “subscription of the solution” may refer to a request for use of the solution by installing and using the solution in the image forming apparatus. In a case where a user sets up subscriptions of predetermined solutions to an account of the user through a portal server, the cloud server may install the predetermined solutions on the image forming apparatus registered in the account of the user.

In the present disclosure, an example billing management process with respect to a solution installed in an image forming apparatus will be described. A description of the example billing management process will be given in which accurate billing may be processed for solutions newly installed in or removed from the image forming apparatus through the cloud server and also for solutions newly installed in or removed from the image forming apparatus through other routes. In addition, a description of the example billing management process will be given in which stable billing may be processed by allowing the portal server to separately manage solutions newly installed in or removed from the image forming apparatus in a database. The newly installed solution may include a first installed solution that has not been previously installed on the image forming apparatus, and also a solution that has been removed and then reinstalled or updated even if the solution is a previously installed solution. That is, the newly installed solution is a solution that has not been previously installed or has been removed after installation, and thus, it is not installed in the image forming apparatus at the previous time, but it is installed in the image forming apparatus at the present time.

Hereinafter, various examples will be described with reference to the drawings. Like reference numerals in the specification and the drawings denote like elements, and thus their repeated descriptions will be omitted.

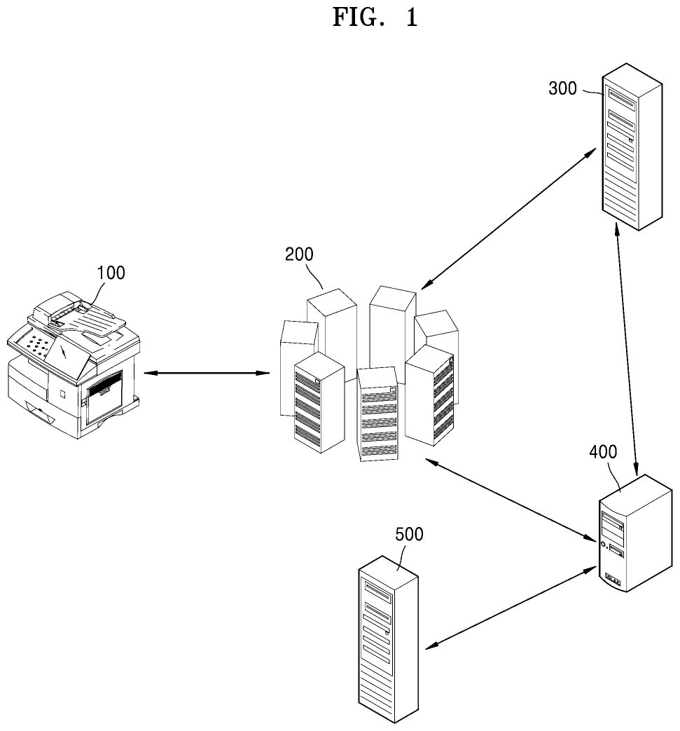

FIG. 1 is a diagram illustrating a service environment in which an image forming apparatus is provided with a solution according to an example.

Referring to FIG. 1, an image forming apparatus 100 generally refers to an apparatus capable of performing an image forming job, such as a printer, a copier, a scanner, a facsimile machine, a multifunction printer, etc. The image forming job may refer to any of various jobs related to an image, for example, printing, copying, scanning, faxing, or related functions, and may include a series of processes required for performing the image forming job.

A cloud server 200 may be a cloud-based platform that provides a solution to the image forming apparatus 100. The cloud server 200 may store and manage an installation file of the solution that may be provided to the image forming apparatus 100 in a database.

In order for the image forming apparatus 100 to receive the solution from the cloud server 200, the image forming apparatus 100 may be registered in an account of a user used in the cloud server 200. Based on the account of the user used in the cloud server 200, the cloud server 200 may provide the solution to the image forming apparatus 100 registered in the account according to the authority of the account. The image forming apparatus 100 may be connected to the cloud server 200 to request the solution and may download the solution or receive the solution provided by the cloud server 200 in a push manner.

A portal server 300 may provide information about the solution that the cloud server 200 may provide. The portal server 300 may also serve as an interface to the cloud server 200 by interconnecting the solution to the account of the user used in the cloud server 200 such that the interconnected solution is provided to the image forming apparatus 100 registered in the account. For example, a reseller may verify the solution information through a solution catalog, through the portal server 300, and configure a solution subscription list corresponding to the reseller's account such that the solution included in the solution subscription list is provided to the image forming apparatus 100 registered in the account. The solution catalog refers to a list of solutions that the cloud server 200 may provide, and the solution subscription list refers to a list of solutions selected by the user in correspondence with the account for installation and use in the image forming apparatus 100. The user, such as the reseller, may have multiple accounts, set up a different solution subscription list for each account, and register different image forming apparatuses for each account.

An event management server 400 may generate an event according to an external request and perform a simple queue service for notifying the event. For example, the event management server 400 may generate the event such as a solution installation event, a solution removal event, or a solution change event requested from the cloud server 200, and the portal server 300 or a billing server 500 may confirm the generated event. If a specific event occurs, the event management server 400 may notify (e.g., publish) that the specific event has occurred. Accordingly, external servers set to interconnect with the occurrence of the specific event perform predetermined operations.

If a solution is installed in or removed from the image forming apparatus 100, the billing server 500 may process billing with respect to the account in which the image forming apparatus 100 is registered. The billing server 500 may start billing with respect to the solution newly installed in the image forming apparatus 100 or stop billing with respect to the solution removed from the image forming apparatus 100.

FIG. 1 is an example of a service environment in which the image forming apparatus 100 is provided with the solution and in which the cloud server 200, the portal server 300, the event management server 400, and the billing server 500 interconnect with each other. However, implementation of such distributed servers is an example and other examples are not limited thereto. Among the cloud server 200, the portal server 300, the event management server 400, and the billing server 500, functions of some servers may be substituted by other servers or excluded, and a plurality of servers among these servers may also be integrated into one server. For example, in a case where the event management server 400 is excluded, information may be directly transmitted and received between other servers without an event being relayed through the event management server 400. For another example, the cloud server 200, the portal server 300, and the billing server 500 may be implemented as one server, and operations of several servers may be performed in one server. Hereinafter, for convenience of description, the service environment disclosed in FIG. 1 is assumed.

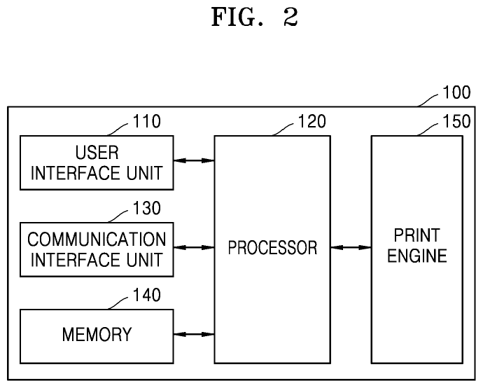

FIG. 2 is a diagram illustrating an image forming apparatus according to an example.

Referring to FIG. 2, the image forming apparatus 100 may include a user interface unit 110, a processor 120, a communication interface unit 130, a memory 140, and a print engine 150. In addition, although not shown, the image forming apparatus 100 may further include a power supply unit for supplying power to the respective components.

The user interface unit 110 may include an input unit for receiving an input for performing an image forming job from a user, and an output unit for displaying information such as a result of performing the image forming job or a state of the image forming apparatus 100.

The processor 120 may control an operation of the image forming apparatus 100 and may include at least one processor such as a central processing unit (CPU). The processor 120 may control other components included in the image forming apparatus 100 to perform an operation corresponding to the user input received through the user interface unit 110. The processor 120 may include at least one specialized processor corresponding to a predetermined function. The processor 120 may execute a program stored in the memory 140, read data or files stored in the memory 140, or store a new program or application in the memory 140.

The communication interface unit 130 may perform wired or wireless communication with another device or a network. To this end, the communication interface unit 130 may include a communication module (e.g., transceiver) supporting at least one of various wired and wireless communication methods. The communication interface unit 130 may be connected to an external apparatus of the image forming apparatus 100 to transmit and receive signals or data. The image forming apparatus 100 may be connected to the cloud server 200 through the communication interface unit 130.

The memory 140 may store various types of program files or data such as software packages, application programs, applications, etc. The processor 120 may access and use the files or the data stored in the memory 140 or store new files or data in the memory 140. In addition, the processor 120 may install and execute a program stored in the memory 140 in the image forming apparatus 100. The processor 120 may install and execute a solution in the form of an application or firmware received from the cloud server 200 through the communication interface unit 130 on the image forming apparatus 100.

The print engine 150 may include both hardware and software to perform an image forming job such as copying, printing, scanning, or faxing, and may include modules such as a printing unit, a scanning unit, and a faxing unit. The printing unit may form an image on a recording medium by various printing methods such as an electrophotographic method, an inkjet method, a thermal transfer method, a thermal method, or the like. The scanning unit may irradiate light onto a document, receive reflected light, and read an image recorded on the document. In the faxing unit, a configuration for scanning an image may be shared with the scanning unit, and a configuration for printing a received file may be shared with the printing unit. The faxing unit may transmit a scan file to a destination or receive a file from the an external source.

The image forming apparatus 100 may receive a solution installation file from the cloud server 200 to newly install a solution or remove the solution installed in the image forming apparatus 100. If the solution is installed and executed in the image forming apparatus 100, a predetermined service corresponding to the solution may be provided to the image forming apparatus 100. The image forming apparatus 100 may transmit a solution list indicating solutions installed in the image forming apparatus 100 to the cloud server 200. The cloud server 200 may identify the solution installed in the image forming apparatus 100 through the solution list. The solution list may be transmitted to the cloud server 200 from the image forming apparatus 100 in a case where the cloud server 200 newly installs or removes the solution on the image forming apparatus 100 as well as if there is a request from the cloud server 200 or according to a predetermined period preset in the image forming apparatus 100.

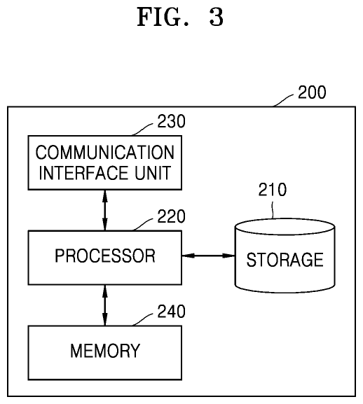

FIG. 3 is a diagram illustrating a cloud server according to an example.

Referring to FIG. 3, the cloud server 200 may include a storage 210, a processor 220, a communication interface unit 230, and a memory 240. The memory 240 may store instructions executable by the processor 220. The processor 220 may control an operation of the cloud server 200 and may include at least one processing unit. The communication interface unit 230 may include a corresponding communication module (e.g., transceiver) to communicate with the communication interface unit 130 of the image forming apparatus 100 described above or communication interface units of other servers. The cloud server 200 may store an installation file or an update file of a solution that may be installed in the image forming apparatus 100 as a database in the storage 210. The cloud server 200 may install the solution on the image forming apparatus 100 according to an external request.

The cloud server 200 may detect a solution newly installed in or removed from the image forming apparatus 100 based on a solution list indicating solutions installed in the image forming apparatus 100. In a case where the solution installed in the image forming apparatus 100 changes, the cloud server 200 may notify the event management server 400 of the fact such that the event management server 400 notifies (e.g., publishes) that a specific event has occurred.

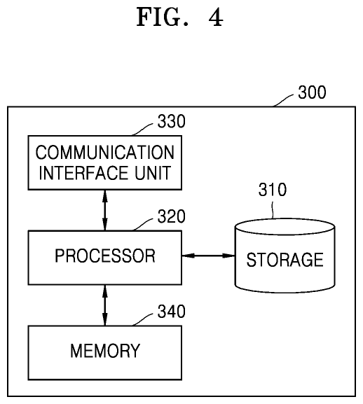

FIG. 4 is a diagram illustrating a portal server according to an example.

Referring to FIG. 4, the portal server 300 may include a storage 310, a processor 320, a communication interface unit 330, and a memory 340. The memory 340 may store instructions executable by the processor 320. The processor 320 may control an operation of the portal server 300 and may include at least one processing unit. The communication interface unit 330 may include a corresponding communication module (e.g., transceiver) to communicate with the communication interface unit 230 of the image forming apparatus 100 or communication interface units of other servers. The portal server 300 may provide information about a solution that the cloud server 200 may provide, and interconnect the solution with an account used in the cloud server 200 such that the solution is provided to the image forming apparatus 100 registered in the account. The portal server 300 may provide a user interface to allow a reseller to confirm the solution information that the cloud server 200 may provide through a solution catalog and to configure a solution subscription list with respect to the account used in the cloud server 200.

The portal server 300 may manage the solution subscription list, and accordingly may request the cloud server 200 to newly install a solution in or remove the solution from the image forming apparatus 100. The portal server 300 may verify whether the solution detected as newly installed in or removed from the image forming apparatus 100 is included in the solution subscription list corresponding to the account in which the image forming apparatus 100 is registered. The portal server 300 may, according to a verification result, request the billing server 500 to process billing with respect to the newly installed or removed solution through the communication interface unit 330. If the solution newly installed in the image forming apparatus 100 is included in the solution subscription list, the portal server 300 may request the billing server 500 to start billing with respect to the newly installed solution. If the solution removed from the image forming apparatus 100 is included in the solution subscription list, the portal server 300 may request the billing server 500 to stop billing with respect to the removed solution. The portal server 300 may share the subscription list with the billing server 500. In addition, in order to ensure stability of a billing management system, the portal server 300 may record and manage the solution detected as newly installed in or removed from the image forming apparatus 100 in a separate database for billing management.

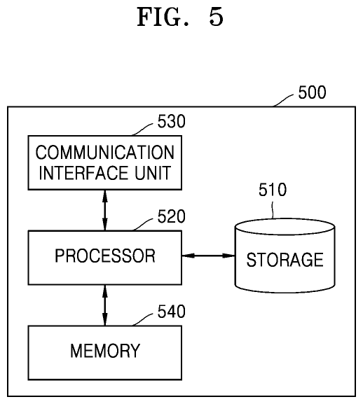

FIG. 5 is a diagram illustrating a billing server according to an example.

Referring to FIG. 5, the billing server 500 may include a storage 510, a processor 520, a communication interface unit 530, and a memory 540. The memory 540 may store instructions executable by the processor 520. The processor 520 may control an operation of the billing server 500 and may include at least one processing unit. The communication interface unit 530 may include a corresponding communication module (e.g., transceiver) to communicate with the communication interface unit 330 of the portal server 300 or a communication interface unit (not shown) of the event management server 400. In a case where a solution is newly installed in or removed from the image forming apparatus 100, the billing server 500 may process billing of the solution for an account in which the image forming apparatus 100 is registered.

The billing server 500 may confirm information of the solution detected as being newly installed in or removed from the image forming apparatus 100. If the detected solution is the solution newly installed in the image forming apparatus 100, the billing server 500 may start billing with respect to the detected solution. On the other hand, if the detected solution is the solution removed from the image forming apparatus 100, the billing server 500 may stop billing with respect to the detected solution. Alternatively, the billing server 500 may verify whether the solution newly installed in or removed from the image forming apparatus 100 is included in a solution subscription list corresponding to an account in which the image forming apparatus 100 is registered, and, according to a verification result, may process billing with respect to the newly installed or removed solution.

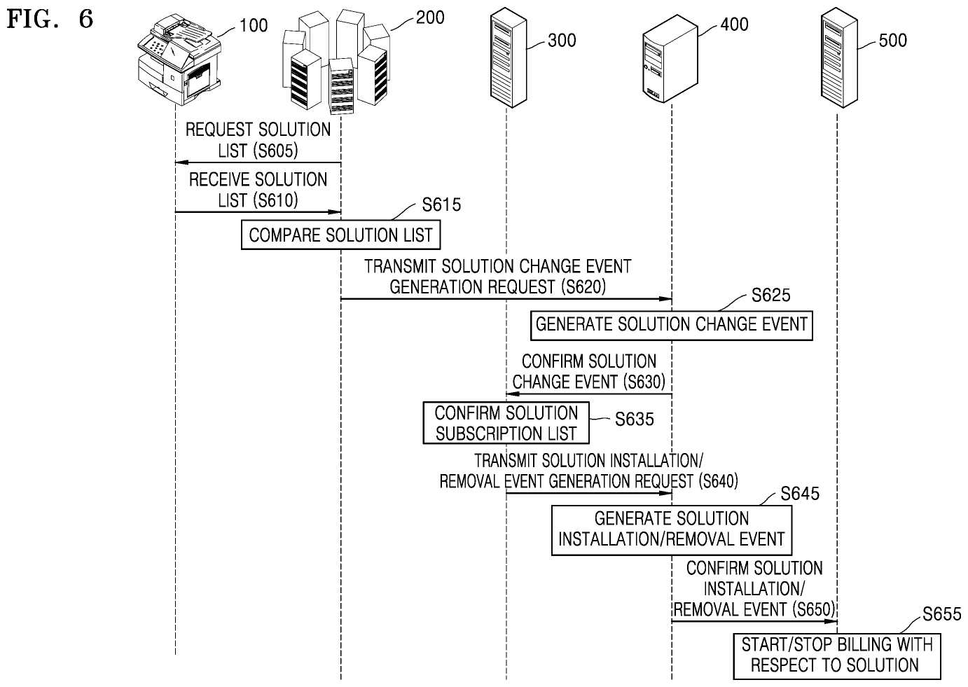

FIG. 6 is a diagram illustrating a billing process in which a cloud server periodically detects a solution newly installed in or removed from an image forming apparatus, and a portal server confirms a solution subscription list stored in the portal server to request billing according to an example.

Referring to FIG. 6, the cloud server 200 may transmit a request for a solution list indicating solutions installed in the image forming apparatus 100 to the image forming apparatus 100 in operation S605. The cloud server 200 may request the solution list from the image forming apparatus 100 if a predetermined condition is satisfied or a predetermined period is reached.

The cloud server 200 may receive the solution list from the image forming apparatus 100 in operation S610. The cloud server 200 may receive a solution list that is most recently updated in the image forming apparatus 100 from the image forming apparatus 100, in response to the request for the solution list to the image forming apparatus 100.

The cloud server 200 may compare the solution list received from the image forming apparatus 100 with a solution list stored in the cloud server 200 to detect the solution newly installed in or removed from the image forming apparatus 100 in operation S615. The cloud server 200 may manage a solution list indicating solutions provided for the image forming apparatus 100 in a database, and compare the solution list with the solution list received from the image forming apparatus 100 to detect whether there is a change in the solutions installed in the image forming apparatus 100. The cloud server 200 may compare the two solution lists, and if there is a difference between identified solutions, may determine that there is a solution change.

The cloud server 200 may transmit a solution change event generation request to the event management server 400 in operation S620. The cloud server 200 may transmit the solution change event generation request together with information of the detected solution to the event management server 400 if a solution is detected as being newly installed in or removed from the image forming apparatus 100. In an example, the cloud server 200 may indirectly transmit the information of the solution detected as being newly installed or removed to the portal server 300 through the relay of the event management server 400. In another example, but without the event management server 400, the cloud server 200 may directly transmit the information of the solution detected as being newly installed or removed to the portal server 300.

The event management server 400 may generate and publish a solution change event in operation S625. The event management server 400 may publish the fact that the solution change event has been generated at the request of the cloud server 200.

The portal server 300 may confirm the solution change event published by the event management server 400 in operation S630. The portal server 300 may receive the information of the solution detected as being newly installed in or removed from the image forming apparatus 100 from the event management server 400. The portal server 300 may periodically monitor events published by the event management server 400 or may previously set the event management server 400 to notify the fact that the solution change event has been generated.

The portal server 300 may confirm a solution subscription list to verify whether the solution detected as newly installed in or removed from the image forming apparatus 100 is subject to billing in operation S635. The portal server 300 may have the solution subscription list corresponding to accounts in which the image forming apparatus 100 is registered.

If the solution detected as being newly installed in or removed from the image forming apparatus 100 is included in the solution subscription list, the portal server 300 may determine that billing is to be processed and transmit a solution installation event generation request or a solution removal event generation request to the event management server 400 in operation S640. The portal server 300 may transmit the solution installation event generation request or the solution removal event generation request together with information about the detected solution to the event management server 400. In an example, the portal server 300 indirectly requests billing from the billing server 500 through the relay of the event management server 400. In another example, but without the event management server 400, the portal server 300 may directly request billing from the billing server 500.

The event management server 400 may generate and publish a solution installation event or a solution removal event in operation S645. The event management server 400 may publish the fact that the solution installation event or the solution removal event has been generated according to the request of the portal server 300.

The billing server 500 may confirm the solution installation event or the solution removal event published by the event management server 400 in operation S650. The billing server 500 may receive information of the solution detected as being newly installed in or removed from the image forming apparatus 100 from the event management server 400. The billing server 500 may periodically monitor events published by the event management server 400 or may previously set the event management server 400 to notify the fact that the solution installation event or the solution removal event has been generated.

The billing server 500 may process billing with respect to the solution detected as being newly installed in or removed from the image forming apparatus 100 in operation S655. The billing server 500 may start billing with respect to the detected solution if the detected solution is the newly installed solution in the image forming apparatus 100, and may stop billing with respect to the detected solution if the detected solution is the solution removed from the image forming apparatus 100.

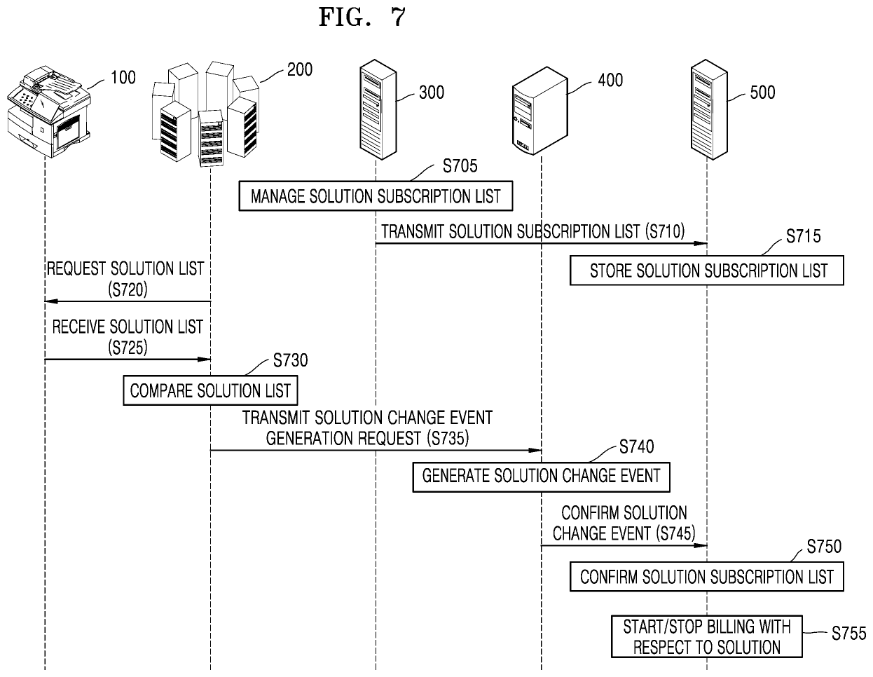

FIG. 7 is a diagram illustrating a billing process in which a cloud server periodically detects a solution newly installed in or removed from an image forming apparatus, and a billing server confirms a solution subscription list received from a portal server to process billing according to an example.

Upon comparing the billing process of FIG. 6 as described above and the billing process of FIG. 7, it may be seen that the billing process of FIG. 7 shows that the portal server 300 shares the solution subscription list with the billing server 500 such that the billing server 500 is interconnected with a solution change event published by the event management server 400 to process billing. In that regard, operations S720 to S740 of FIG. 7 respectively correspond to operations S605 to S625 of FIG. 6 described above, and thus detailed descriptions thereof will be omitted.

Referring to FIG. 7, the portal server 300 may manage solutions selected by a user in correspondence with an account for installation and use in the image forming apparatus 100 as the solution subscription list in operation S705. As an example, a reseller may configure the solution subscription list corresponding to his/her account through the portal server 500 such that solutions included in the solution subscription list are provided to the image forming apparatus 100 registered in the account.

The portal server 300 may transmit the solution subscription list to the billing server 500 in operation S710. If the solution subscription list is updated, the portal server 300 may transmit information about an updated solution to the billing server 500.

The billing server 500 may store and manage the solution subscription list received from the portal server 300 in operation S715. Accordingly, if there is a billing management request from an external source, the billing server 500 may confirm the solution subscription list to verify whether the solution is subject to billing.

The cloud server 200 may transmit a request for a solution list indicating solutions installed in the image forming apparatus 100 to the image forming apparatus 100 in operation S720. The cloud server 200 may receive the solution list from the image forming apparatus 100 in operation S725. The cloud server 200 may compare the solution list received from the image forming apparatus 100 with a solution list stored in the cloud server 200 to detect the solution newly installed in or removed from the image forming apparatus 100 in operation S730. The cloud server 200 may transmit the solution change event generation request together with information of the detected solution to the event management server 400 if a solution is detected as being newly installed in or removed from the image forming apparatus 100 in operation S735. The event management server 400 may generate and publish the solution change event in operation S740.

The billing server 500 may confirm the solution change event published by the event management server 400 in operation S745. The billing server 500 may receive the information of the solution detected as being newly installed in or removed from the image forming apparatus 100 from the event management server 400. The billing server 500 may periodically monitor events published by the event management server 400 or may previously set the event management server 400 to notify the fact that the solution change event has occurred.

The billing server 500 may confirm the solution subscription list to verify whether the solution detected as newly installed in or removed from the image forming apparatus 100 is subject to billing in operation S750. The billing server 500 may previously have the solution subscription list corresponding to accounts in which the image forming apparatus 100 is registered, according to the process of operations S705 to S715 described above. If the solution detected as being newly installed in or removed from the image forming apparatus 100 is included in the solution subscription list, the billing server 500 may determine that billing is to be processed.

The billing server 500 may process billing with respect to the solution detected as being newly installed in or removed from the image forming apparatus 100 in operation S755. The billing server 500 may start billing with respect to the detected solution if the detected solution is the newly installed solution in the image forming apparatus 100, and stop billing with respect to the detected solution if the detected solution is the solution removed from the image forming apparatus 100.

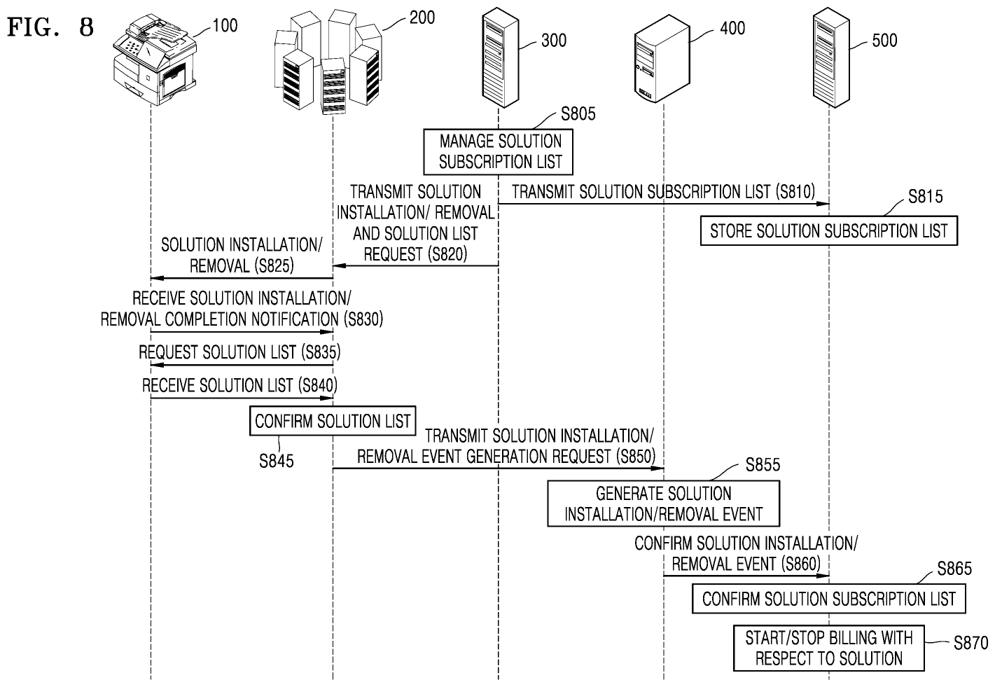

FIG. 8 is a diagram illustrating a billing process in which a cloud server newly installs or removes a solution in or from an image forming apparatus, and a billing server confirms a solution subscription list received from a portal server to process billing according to an example.

Upon comparing the billing process of FIG. 7 as described above and the billing process of FIG. 8, it may be seen that the billing process of FIG. 8 shows that the cloud server 200 newly installs or removes the solution in or from the image forming apparatus 100 according to a request of the portal server 300 such that the billing server 500 is interconnected with a solution installation event or a solution removal event published by the event management server 400 to process billing. In that regard, operations S805 to S815, S865, and S870 of FIG. 8 respectively correspond to operations S705 to S715, S750, and S755 of FIG. 7 described above, and thus detailed descriptions thereof will be omitted.

Referring to FIG. 8, the portal server 300 may manage solutions selected by a user in correspondence with an account for installation and use in the image forming apparatus 100 as the solution subscription list in operation S805. The portal server 300 may transmit the solution subscription list to the billing server 500 in operation S810. The billing server 500 may store and manage the solution subscription list received from the portal server 300 in operation S815.

The portal server 300 may request the cloud server 200 to newly install or remove the solution in or from the image forming apparatus 100 according to the solution subscription list managed by the portal server 300 in operation S820. Further, the portal server 300 may request the cloud server 200 to transmit a solution list request to the image forming apparatus 100.

The cloud server 200 may newly install or remove the solution in or from the image forming apparatus 100 in operation S825. The cloud server 200 may query an installation file or a removal file of the solution according to the request of the portal server 300 from a database, and transmit the installation file or the removal file of the solution to the image forming apparatus 100.

The cloud server 200 may receive an installation completion notification of the solution or a removal completion notification of the solution from the image forming apparatus 100 in operation S830. The image forming apparatus 100 may execute the installation file or removal file of the solution received from the cloud server 200, and if the installation or removal of the solution is completed, transmit the installation completion notification of the solution or the removal completion notification of the solution to the cloud server 200.

The cloud server 200 may transmit a request for a solution list indicating solutions installed in the image forming apparatus 100 to the image forming apparatus 100 in operation S835. The cloud server 200 may request the solution list from the image forming apparatus 100 after the installation completion notification of the solution or the removal completion notification of the solution is received.

The cloud server 200 may receive the solution list from the image forming apparatus 100 in operation S840. The cloud server 200 may receive, from the image forming apparatus 100, a solution list reflecting information of a solution that is most recently installed in or removed from the image forming apparatus 100, in response to a request for the solution list to the image forming apparatus 100.

After newly installing or removing the solution in or from the image forming apparatus 100, the cloud server 200 may confirm, from the solution list received from the image forming apparatus 100, whether there is a solution newly installed in or removed from the image forming apparatus 100, thereby detecting the solution newly installed in or removed from the image forming apparatus 100 in operation S845. That is, after completing the installation or removal of the solution, the cloud server 200 may confirm whether the newly installed or removed solution is included in the solution list received from the image forming apparatus 100, thereby detecting the solution newly installed in or removed from the image forming apparatus 100.

If the solution is detected as being newly installed in or removed from the image forming apparatus 100, the cloud server 200 may determine that billing is to be processed and transmit the solution installation event or the solution removal event to the event management server 400 in operation S850. The cloud server 200 may transmit a solution installation event generation request or a solution removal event generation request together with information of the detected solution to the event management server 400.

The event management server 400 may generate and publish the solution installation event or the solution removal event in operation S855. The event management server 400 may publish the fact that the solution installation event or the solution removal event has occurred according to a request of the cloud server 200.

The billing server 500 may confirm the solution installation event or the solution removal event published by the event management server 400 in operation S860. The billing server 500 may receive the information of the solution detected as being newly installed in or removed from the image forming apparatus 100 from the event management server 400. The billing server 500 may periodically monitor events published by the event management server 400 or may previously set the event management server 400 to notify the fact that the solution installation event or the solution removal event has occurred.

The billing server 500 may confirm the solution subscription list to verify whether the solution detected as newly installed in or removed from the image forming apparatus 100 is subject to billing in operation S865. The billing server 500 may start billing with respect to the detected solution if the detected solution is the newly installed solution in the image forming apparatus 100. On the other hand, the billing server 500 may stop billing with respect to the detected solution if the detected solution is the solution removed from the image forming apparatus 100 in operation S870.

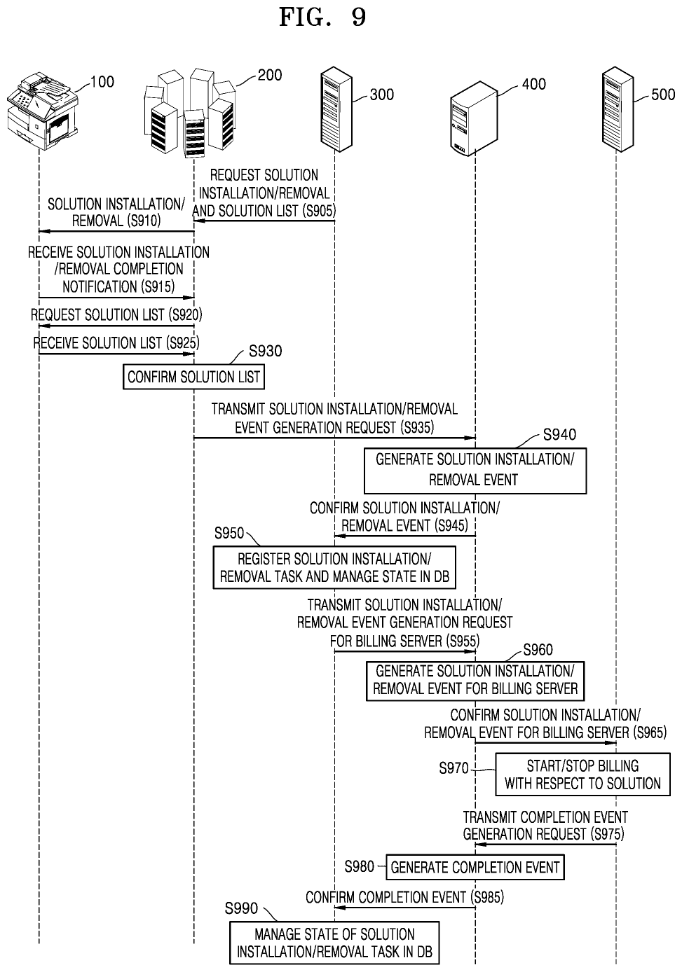

FIG. 9 is a diagram illustrating a billing process in which a portal server manages a solution in which a cloud server newly installs in or removes from an image forming apparatus in a database and confirms a solution subscription list stored in the portal server to request billing according to an example.

Upon comparing the billing process of FIG. 8 as described above and the billing process of FIG. 9, it may be seen that the billing process of FIG. 9 shows that in order to ensure the stability of a billing management system, the portal server 300 records and manages the solution detected as newly installed in or removed from the image forming apparatus 100 in a separate database for billing management. The portal server 300 may classify whether the detected solution is newly installed or removed and register the solution in the database as a task, and change a state of the task registered in the database according to a billing progress with respect to the detected solution. In that regard, operations S905 to S940 of FIG. 9 respectively correspond to operations S820 to S855 of FIG. 8 described above, and thus detailed descriptions thereof will be omitted.

Referring to FIG. 9, the portal server 300 may request the cloud server 200 to newly install or remove the solution in or from the image forming apparatus 100 according to the solution subscription list managed by the portal server 300 and request the cloud server 200 to transmit a solution list request to the image forming apparatus 100 in operation S905. The cloud server 200 may newly install or remove the solution in or from the image forming apparatus 100 according to a request of the portal server 300 in operation S910. The cloud server 200 may receive an installation completion notification of the solution or a removal completion notification of the solution from the image forming apparatus 100 in operation S915. The cloud server 200 may transmit a request for a solution list indicating solutions installed in the image forming apparatus 100 to the image forming apparatus 100 in operation S920. The cloud server 200 may receive the solution list from the image forming apparatus 100 in operation S925. After newly installing or removing the solution in or from the image forming apparatus 100, the cloud server 200 may confirm from the solution list received from the image forming apparatus 100 whether there is a solution newly installed in or removed from the image forming apparatus 100, thereby detecting the solution newly installed in or removed from the image forming apparatus 100 in operation S930. If the solution is detected as being newly installed in or removed from the image forming apparatus 100, the cloud server 200 may determine that billing is to be processed and transmit the solution installation event or the solution removal event to the event management server 400 in operation S935. The event management server 400 may generate and publish the solution installation event or the solution removal event in operation S940.

The portal server 300 may confirm the solution installation event or the solution removal event published by the event management server 400 in operation S945. The portal server 300 may receive the information of the solution detected as being newly installed in or removed from the image forming apparatus 100 from the event management server 400. The portal server 300 may periodically monitor events published by the event management server 400 or may previously set the event management server 400 to notify the fact that the solution installation event or the solution removal event has occurred.

The portal server 300 may classify whether the detected solution is newly installed in or removed from the database and register the solution as the task, and, according to a result of verifying whether the detected solution is included in the solution subscription list, change a state of the task from a ready state to an activation state in operation S950. The portal server 300 may request billing with respect to the detected solution corresponding to the task changed to the activation state.

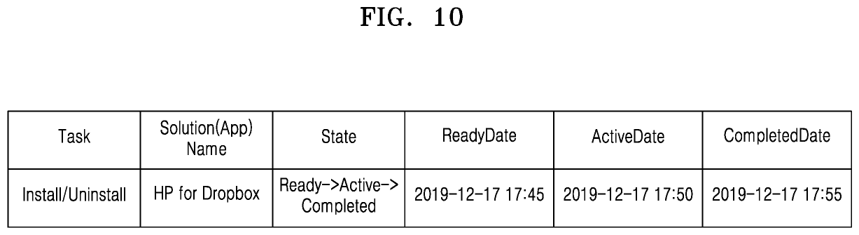

FIG. 10 is a diagram illustrating a database managed by a portal server according to an example.

Referring to FIG. 10, in a case where a solution “HP for Dropbox” is newly installed in or removed from the image forming apparatus 100, the portal server 300 may distinguish whether the solution “HP for Dropbox” is newly installed or removed and register the solution “HP for Dropbox” in the database as a task. At this time, a state of an installation task or a removal task corresponding to the solution “HP for Dropbox” may be set to a ready state, and the date and time may be recorded as “2019 Dec. 17 17:45”. Thereafter, the portal server 300 may change the state of the installation task or the removal task corresponding to “HP for Dropbox” from the ready state to an activation state according to a result of verifying whether the solution “HP for Dropbox” is included in a solution subscription list and record the date and time as “2019 Dec. 17 17:50”. As described above, if the state of the installation task or the removal task corresponding to the solution “HP for Dropbox” is activated, the portal server 300 may request billing with respect to the solution “HP for Dropbox”.

Referring back to FIG. 9, the portal server 300 may transmit a solution installation event generation request for the billing server 500 or a solution removal event generation request for the billing server 500 to the event management server 400 in operation S955. The portal server 300 may transmit the solution installation event generation request for the billing server 500 or the solution removal event generation request for the billing server 500 together with information of the detected solution to the event management server 400.

The event management server 400 may generate and publish a solution installation event for the billing server 500 or a solution removal event for the billing server 500 in operation S960. The event management server 400 may publish the fact that the solution installation event for the billing server 500 or the solution removal event for the billing server 500 has occurred according to a request of the portal server 300.

The billing server 500 may confirm the solution installation event for the billing server 500 or the solution removal event for the billing server 500 published by the event management server 400 in operation S965. The billing server 500 may receive the information of the solution detected as being newly installed in or removed from the image forming apparatus 100 from the event management server 400. The billing server 500 may periodically monitor events published by the event management server 400 or may previously set the event management server 400 to notify the fact that the solution installation event for the billing server 500 or the solution removal event for the billing server 500 has occurred.

The billing server 500 may process billing with respect to the solution detected as newly installed in or removed from the image forming apparatus 100 in operation S970. The billing server 500 may start billing with respect to the detected solution if the detected solution is the newly installed solution in the image forming apparatus 100. On the other hand, the billing server 500 may stop billing with respect to the detected solution if the detected solution is the solution removed from the image forming apparatus 100.

The billing server 500 may transmit a completion event generation request to the event management server 400 in operation S975. The billing server 500 may transmit the completion event generation request together with information of the solution on which billing is processed to the event management server 400.

The event management server 400 may generate and publish a completion event in operation S980. The event management server 400 may publish the fact that the completion event has occurred at the request of the billing server 500.

The portal server 300 may confirm the completion event published by the event management server 400 in operation S985. The portal server 300 may receive information of the solution on which billing is processed by the billing server 500 from the event management server 400.

The portal server 300 may change the state of the task corresponding to the solution on which billing is processed by the billing server 500 in the database from an activation state to a completion state in operation S990. Accordingly, the portal server 300 may confirm that billing has been processed on the solution corresponding to the task changed to the completion state.

Referring to FIG. 10 again, the portal server 300 may change the state of the installation task or the removal task corresponding to “HP for Dropbox” from the activation state to the completion state, and record the date and time as “2019 Dec. 17 17:55”. As described above, if the state of the installation task or the removal task corresponding to the solution “HP for Dropbox” is completed, the portal server 300 may be known that billing with respect to the solution “HP for Dropbox” has been processed.

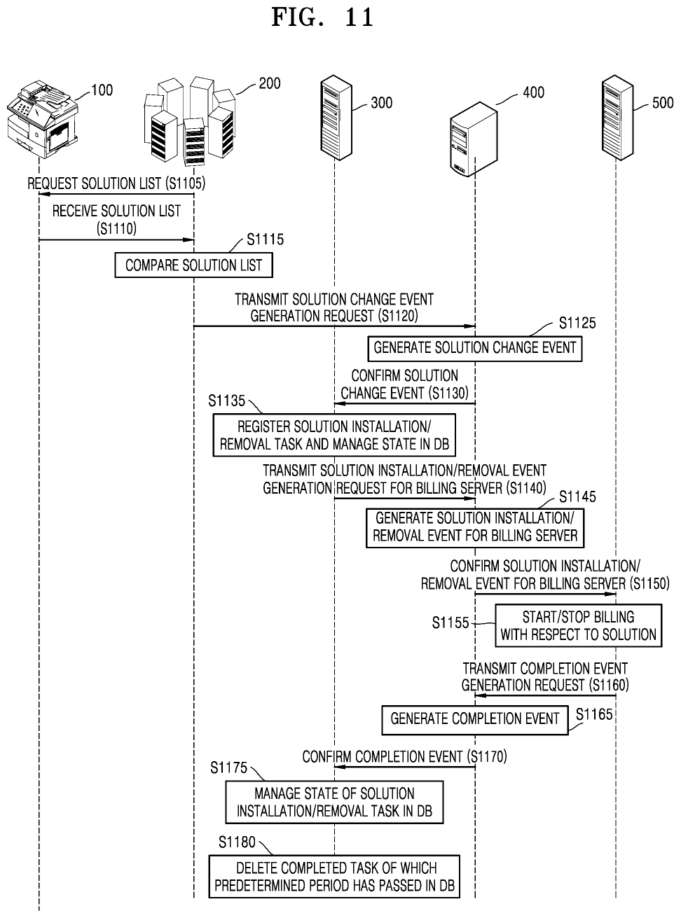

FIG. 11 is a diagram illustrating a billing process in which a cloud server periodically detects a solution newly installed in or removed from an image forming apparatus, and a portal server manages the detected solution in a database and confirms a solution subscription list stored in the portal server to request billing according to an example.

Upon comparing the billing process of FIG. 9 as described above and the billing process of FIG. 11, it may be seen that the billing process of FIG. 11 shows that the cloud server 200 transmits the solution list request to the image forming apparatus 100 to start the billing process without newly installing or removing a solution in or from the image forming apparatus 100. In that regard, operations S1135 to S1175 in FIG. 9 respectively correspond to operations S950 to S990 in FIG. 9 described above, and thus detailed descriptions thereof will be omitted.

Referring to FIG. 11, the cloud server 200 may transmit a request for a solution list indicating solutions installed in the image forming apparatus 100 to the image forming apparatus 100 in operation S1105. The cloud server 200 may request the solution list from the image forming apparatus 100 if a predetermined condition is satisfied or a predetermined period is reached.

The cloud server 200 may receive the solution list from the image forming apparatus 100 in operation S1110. The cloud server 200 may receive a solution list that is most recently updated in the image forming apparatus 100 from the image forming apparatus 100, in response to the request for the solution list to the image forming apparatus 100.

The cloud server 200 may compare the solution list received from the image forming apparatus 100 with a solution list stored in the cloud server 200 to detect the solution newly installed in or removed from the image forming apparatus 100 in operation S1115. The cloud server 200 may manage a solution list indicating solutions provided for the image forming apparatus 100 in a database, and compare the solution list with the solution list received from the image forming apparatus 100 to detect whether there is a change in the solutions installed in the image forming apparatus 100. The cloud server 200 may compare the two solution lists, and if there is a difference between identified solutions, may determine that there is a solution change.

The cloud server 200 may transmit a solution change event generation request to the event management server 400 in operation S1120. The cloud server 200 may transmit the solution change event generation request together with information of the detected solution to the event management server 400 if a solution is detected as being newly installed in or removed from the image forming apparatus 100.

The event management server 400 may generate and publish a solution change event in operation S1125. The event management server 400 may publish the fact that the solution change event has been generated at the request of the cloud server 200.

The portal server 300 may confirm the solution change event published by the event management server 400 in operation S1130. The portal server 300 may receive the information of the solution detected as being newly installed in or removed from the image forming apparatus 100 from the event management server 400.

The portal server 300 may classify whether the detected solution is newly installed in or removed from the database and register the solution as the task, and, according to a result of verifying whether the detected solution is included in the solution subscription list, change a state of the task from a ready state to an activation state in operation S1135. The portal server 300 may transmit a solution installation event generation request for the billing server 500 or a solution removal event generation request for the billing server 500 to the event management server 400 in operation S1140. The event management server 400 may generate and publish a solution installation event for the billing server 500 or a solution removal event for the billing server 500 in operation S1145. The billing server 500 may confirm the solution installation event for the billing server 500 or the solution removal event for the billing server 500 published by the event management server 400 in operation S1150. The billing server 500 may process billing with respect to the solution detected as newly installed in or removed from the image forming apparatus 100 in operation S1155. The billing server 500 may transmit a completion event generation request to the event management server 400 in operation S1160. The event management server 400 may generate and publish a completion event in operation S1165. The portal server 300 may confirm the completion event published by the event management server 400 in operation S1170. The portal server 300 may change the state of the task corresponding to the solution on which billing is processed by the billing server 500 in the database from an activation state to a completion state in operation S1175.

In an example, the portal server 300 may delete a task of the completion state of which a predetermined period has passed from the database as a process for storage space management of the database in operation S1180. Because the state of the task is in the completion state means that billing corresponding to the task has already been processed, the portal server 300 may delete the task from the database.

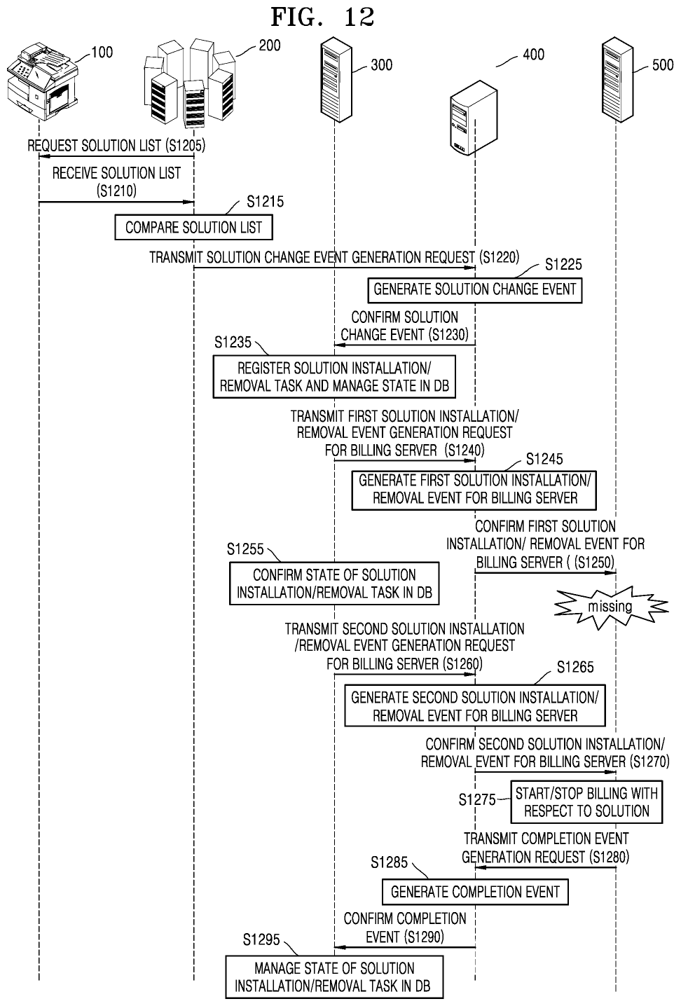

FIG. 12 is a diagram illustrating a billing process in which a cloud server periodically detects a solution newly installed in or removed from an image forming apparatus, and a portal server manages the detected solution in a database and confirms a solution subscription list stored in the portal server to periodically request billing according to an example.

Upon comparing the billing process of FIG. 11 as described above and the billing process of FIG. 12, it may be seen that the billing process of FIG. 12 shows that the portal server 300 re-requests billing with respect to the solution corresponding to a task of which a state has been changed to an activation state until the state of the task is changed to a completion state. In that regard, operations S1205 to S1250 and S1275 to S1295 in FIG. 12 correspond to operations S1105 to S1150 and S1155 to S1175 in FIG. 11 described above, and thus detailed descriptions thereof will be omitted.

Referring to FIG. 12, the cloud server 200 may transmit a request for a solution list indicating solutions installed in the image forming apparatus 100 to the image forming apparatus 100 in operation S1205. The cloud server 200 may receive the solution list from the image forming apparatus 100 in operation S1210. The cloud server 200 may compare the solution list received from the image forming apparatus 100 with a solution list stored in the cloud server 200 to detect the solution newly installed in or removed from the image forming apparatus 100 in operation S1215. The cloud server 200 may transmit a solution change event generation request to the event management server 400 in operation S1220. The event management server 400 may generate and publish a solution change event in operation S1225. The portal server 300 may confirm the solution change event published by the event management server 400 in operation S1230. The portal server 300 may classify whether the detected solution is newly installed in or removed from the database and register the solution as the task, and, according to a result of verifying whether the detected solution is included in the solution subscription list, change a state of the task from a ready state to an activation state in operation S1235. The portal server 300 may transmit a first solution installation event generation request for the billing server 500 or a first solution removal event generation request for the billing server 500 to the event management server 400 in operation S1240. The event management server 400 may generate and publish a first solution installation event for the billing server 500 or a first solution removal event for the billing server 500 in operation S1245. The billing server 500 may confirm the first solution installation event for the billing server 500 or the first solution removal event for the billing server 500 published by the event management server 400 in operation S1250.

At this time, in a case where an error occurs in the event management server 400, the process corresponding to operations S1240 to S1250 above does not proceed partially, and an error occurs in the billing process, the billing server 500 may not process billing with respect to the solution detected as newly installed in or removed from the image forming apparatus 100. In preparation for such a case, the portal server 300 may re-request billing with respect to the solution corresponding to the task, as described below, with respect to a task recorded in the activation state with reference to the database.

The portal server 300 may query the task of which state is the activation state in the database in operation S1255. The portal server 300 may query the task of which state is the activation state in which the state of the task is not changed to the completion state, and re-request billing with respect to the solution corresponding to the task.

The portal server 300 may transmit a second solution installation event generation request for the billing server 500 or a second solution removal event generation request for the billing server 500 to the event management server 400 in operation S1260. The portal server 300 may transmit the second solution installation event generation request for the billing server 500 or the second solution removal event generation request for the billing server 500 together with information of the solution corresponding to the task in the activation state to the event management server 400.

The event management server 400 may generate and publish a second solution installation event for the billing server 500 or a second solution removal event for the billing server 500 in operation S1265.

The billing server 500 may confirm the second solution installation event for the billing server 500 or the second solution removal event for the billing server 500 published by the event management server 400 in operation S1270. The billing server 500 may confirm the information of the solution transmitted from the portal server 300 together.

The billing server 500 may process billing with respect to a solution detected as newly installed in or removed from the image forming apparatus 100 in operation S1275. The billing server 500 may transmit a completion event generation request to the event management server 400 in operation S1280. The event management server 400 may generate and publish a completion event in operation S1285. The portal server 300 may confirm the completion event published by the event management server 400 in operation S1290. The portal server 300 may change the state of the task corresponding to the solution on which billing is processed by the billing server 500 in the database from the activation state to the completion state in operation S1295.

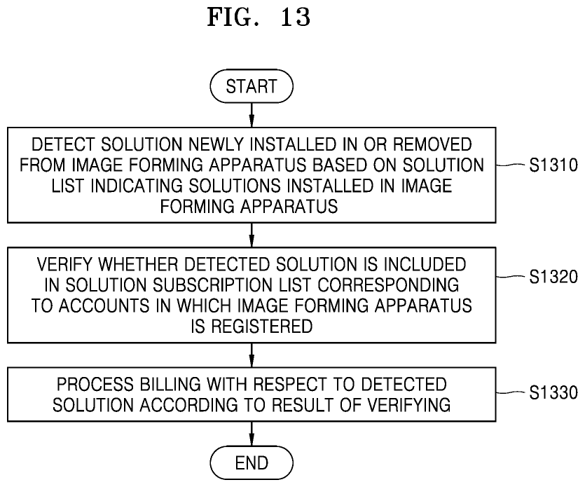

FIG. 13 is a flowchart illustrating a billing management method with respect to a solution installed in an image forming apparatus according to an example.

Referring to FIG. 13, a billing management system may be implemented with several distributed servers, such as the cloud server 200, the portal server 300, the event management server 400, and the billing server 500, functions of some of the servers may be substituted by other servers or excluded, and a plurality of servers may also be integrated into one server.

In operation S1310, the billing management system may detect a solution newly installed in or removed from the image forming apparatus 100 based on a solution list indicating solutions installed in the image forming apparatus 100. For example, the cloud server 200 of the billing management system may compare a solution list periodically received from the image forming apparatus 100 with a solution list stored in the cloud server 200 to detect the solution newly installed in or removed from the image forming apparatus 100. The solution list periodically received from the image forming apparatus 100 may be transmitted to the cloud server 200 from the image forming apparatus 100 according to a periodic request from the cloud server 200 or according to a predetermined period preset in the image forming apparatus 100. In this case, the solution newly installed in or removed from the image forming apparatus 100 may be detected through other routes other than the cloud server 200. As another example, after newly installing or removing the solution in or from the image forming apparatus 100, the cloud server 200 of the billing management system may confirm from the solution list received from the image forming apparatus 100 whether there is a solution newly installed in or removed from the image forming apparatus 100, thereby detecting the solution newly installed in or removed from the image forming apparatus 100. That is, after newly installing or removing the solution in or from the image forming apparatus 100, the cloud server 200 may confirm whether the newly installed or removed solution is included in the solution list received from the image forming apparatus 100, thereby detecting the solution newly installed in or removed from the image forming apparatus 100.

In operation S1320, the billing management system may verify whether the detected solution is included in a solution subscription list corresponding to accounts in which the image forming apparatus 100 is registered. The portal server 300 or the billing server 500 of the billing management system may have the solution subscription list corresponding to accounts in which the image forming apparatus 100 is registered. The portal server 300 or the billing server 500 of the billing management system may use the solution subscription list to verify whether the solution newly installed in or removed from the image forming apparatus 100 is subject to billing. Accordingly, if the solution detected as being newly installed in or removed from the image forming apparatus 100 is included in the solution subscription list, the billing management system may determine that billing with respect to the solution needs to be processed. For example, if the solution detected as being removed from the image forming apparatus 100 is included in the solution subscription list, the billing management system may determine that billing with respect to the solution needs to stop.

The portal server 300 of the billing management system may set a billing processing state of the detected solution according to a result of verifying whether the detected solution is included in the solution subscription list, and request billing with respect to the detected solution according to the set billing processing state. If the detected solution is included in the solution subscription list, the portal server 300 of the billing management system may set the billing processing state of the detected solution from a ready state to an activation state. The portal server 300 of the billing management system may periodically request billing with respect to the detected solution until the set billing processing state is set to a completion state. The portal server 300 of the billing management system may change the set billing processing state from the activation state to a completion state later if billing with respect to the detected solution is processed. More specifically, in order to ensure stability of the billing management system, the portal server 300 of the billing management system may record and manage the solution detected as newly installed in or removed from the image forming apparatus 100 in a separate database for billing management. The portal server 300 of the billing management system may classify whether the detected solution is newly installed in or removed from the database and register the solution as the task, and according to a result of verifying whether the detected solution is included in the solution subscription list, change the state of the task from the ready state to the activation state. The portal server 300 of the billing management system may request billing with respect to the detected solution corresponding to the task changed to the activation state. The portal server 300 of the billing management system may periodically request billing with respect to the detected solution until the state of the task changed to the activation state is changed to the completion state. The portal server 300 of the billing management system may change the state of the task from the activation state to the completion state later if billing with respect to the detected solution is processed.

In operation S1330, the billing management system may process billing with respect to the solution detected as being newly installed in or removed from the image forming apparatus 100 according a result of verifying whether the solution detected as newly installed in or removed from the image forming apparatus 100 is included in the solution subscription list. In a case where the detected solution is included in the solution subscription list, if the detected solution is the solution newly installed in the image forming apparatus 100, the billing server 500 of the billing management system may start billing with respect to the detected solution. On the other hand, if the detected solution is the solution removed from the image forming apparatus 100, the billing server 500 of the billing management system may stop billing with respect to the detected solution.

An example billing management method with respect to a solution installed in the image forming apparatus 100 described above may be in part or completely implemented by a non-transitory computer-readable storage medium storing instructions or data executable by an image forming apparatus, a computer or a processor. The examples may be written as computer programs and may be implemented in general-use digital computers that execute the programs by using a non-transitory computer-readable storage medium. Examples of the non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-status disks (SSDs), and instructions or software, associated data, data files, and data structures, and any device capable of providing instructions or software, associated data, data files, and data structures to a processor or a computer such that the processor or computer may execute instructions.

What is claimed is:

1. A billing management method comprising:
detecting a solution newly installed in or removed from an image forming apparatus, based on a solution list indicating solutions installed in the image forming apparatus;
verifying whether the detected solution is included in a solution subscription list corresponding to an account in which the image forming apparatus is registered; and
processing billing with regard to the detected solution according to a result of the verifying.

2. The billing management method of claim 1, wherein the processing of the billing comprises:
in a case where the detected solution is the solution newly installed in the image forming apparatus, starting billing with respect to the detected solution: and
in a case where the detected solution is the solution removed from the image forming apparatus, stopping billing with respect to the detected solution.

3. The billing management method of claim 1, wherein the detecting of the solution comprises detecting the solution newly installed in or removed from the image forming apparatus by comparing the solution list periodically received from the image forming apparatus with a solution list stored in a server.

4. The billing management method of claim 1, wherein the detecting of the solution comprises detecting a newly installed or removed solution from the solution list received from the image forming apparatus after the solution is newly installed in or removed from the image forming apparatus.

5. The billing management method of claim 1, wherein the verifying comprises:
setting a billing processing state of the detected solution according to a result of the verifying whether the detected solution is included in the solution subscription list; and
requesting billing with respect to the detected solution according to the set billing processing state.

6. The billing management method of claim 5, wherein the setting of the billing processing state comprises, in a case where the detected solution is included in the solution subscription list, setting the billing processing state of the detected solution from a ready state to an activation state.

7. The billing management method of claim 5, wherein the requesting of the billing comprises periodically requesting billing with respect to the detected solution until the set billing processing state is set to a completion state.

8. A server comprising:
a communication interface unit;
a memory to store computer executable instructions; and
a processor to:
verify whether a solution newly installed in or removed from an image forming apparatus is included in a solution subscription list corresponding to an account in which the image forming apparatus is registered, and
according to a verification result, request a billing server to process billing with respect to the newly installed or removed solution through the communication interface unit.

9. The server of claim 8, wherein the processor is further to:
in a case where the solution newly installed in the image forming apparatus is included in the solution subscription list, request the billing server to start billing with respect to the newly installed solution, and
in a case where the solution removed from the image forming apparatus is included in the solution subscription list, request the billing server to stop billing with respect to the removed solution.

10. The server of claim 8, wherein the solution newly installed in or removed from the image forming apparatus is detected by comparing a solution list periodically received from the image forming apparatus and indicating solutions installed in the image forming apparatus with a solution list stored in a cloud server providing a solution to the image forming apparatus.

11. The server of claim 8, wherein the solution newly installed in or removed from the image forming apparatus is detected as a newly installed or removed solution from the solution list received from the image forming apparatus after the solution is newly installed in or removed from the image forming apparatus.

12. The server of claim 8, wherein the processor is further to:
set a billing processing state of the newly installed or removed solution according to a verification result as to as to whether the newly installed or removed solution is included in the solution subscription list, and
request billing with respect to the newly installed or removed solution according to the set billing processing state.

13. The server of claim 12, wherein the processor is further to, in a case where the newly installed or removed solution is included in the solution subscription list, set the billing processing state of the newly installed or removed solution from a ready state to an activation state.

14. The server of claim 12, wherein the processor is further to periodically request billing with respect to the newly installed or removed solution until the set billing processing state is set to a completion state.

15. A billing server comprising:
a memory to store computer executable instructions; and
a processor to:
verify whether a solution newly installed in or removed from an image forming apparatus is included in a solution subscription list corresponding to accounts in which the image forming apparatus is registered, and
according to a verification result, process billing with respect to the newly installed or removed solution.
